(19) United States
(12) Patent Application Publication
(10) Pub. No.: US 2008/0187745 A1
(43) Pub. Date: Aug. 7, 2008

(54) Component and method for manufacturing printed circuit boards

(76) Inventor: Miles Justin Russell, Hampstead, NH (US)

Correspondence Address: KEVIN FARRELL;PIERCE ATWOOD, ONE NEW HAMPSHIRE AVENUE, PORTSMOUTH, NH, 03801, US

(21) Appl. No.: 10/606,995

(22) Filed: Jun. 26, 2003

(51) Int. Cl. G11B 11/105; B23B 9/04; B32B 15/04; B32B 27/00; B32B 37/00

(52) U.S. Cl. 428/332; 428/411.1; 428/457; 428/421; 156/60

(57) ABSTRACT

Above-mentioned need is met by the present invention, which provides a laminated component including a separator having first and second surfaces, a conductive film layer disposed against the first surface of the separator, and a non-conductive film layer disposed against the second surface of the separator. The conductive and non-conductive film layers both have larger lateral dimensions than the separator such that a portion of each film layer extends beyond the separator. The extending portions of the conductive and non-conductive film layers are joined together to seal the laminated component. In one embodiment, a band of adhesive is disposed on a first surface of the conductive film layer so as to define an enclosed central area inwardly thereof and the separator is placed within the central area. The extending portion of the non-conductive film layer is pressed against the adhesive to form a joint between the conductive film layer and the non-conductive film layer.

### BACKGROUND OF THE INVENTION

This invention relates generally to printed circuit boards and more particularly to methods and components used for manufacturing printed circuit boards.

Printed circuit boards generally comprise a substrate of a dielectric material having electrically conductive pathways formed thereon. The substrate supports a variety of electronic components connected by the conductive pathways. Printed circuit boards are typically constructed from an epoxy resin-impregnated glass fiber sheet, commonly known as “prepreg,” having a conductive film layer laminated on both sides. The conductive film layers are typically copper foil, although other electrically conductive materials, such as gold or silver foil, can be used. The copper foil is then etched to produce the desired conductive pathways. Multi-level printed circuit boards, also known as interconnect devices, comprise a number of stacked prepreg layers having a conductive “inner layer” interspersed between each pair of adjacent prepreg layers. Each inner layer has circuitry formed on both sides thereof so as to contain two levels of circuitry. An outer layer (typically copper foil) is laminated to the outer surface of each of the outermost two prepreg layers. As with single level printed circuit boards, the outer layers are subsequently etched to produce the desired circuitry.

Printed circuit board manufacturing, particularly of a dense, multi-level printed circuit boards, has undergone a steady evolution over approximately the past fifteen years. The production of the outer layers, which represents some of the final stages in the manufacturing process, is critical to the manufacturer because of the investment of time and materials that has gone into the device up to that point. In other words, substantial resources are expended in producing and assembling the prepreg and inner layers into a laminate (referred to herein as the “core assembly”) that comprises the middle of the multi-level device prior to the manufacture of the outer layers. If either outer layer is manufactured incorrectly, the entire device may need to be scrapped. In the case of a dense, complex device, the lost investment can be substantial.

Manufacture of printed circuit boards typically involves assembling the materials for a plurality of printed circuit boards into a stack, referred to as a book, for collective processing. Early manufacturing methods utilize steel plates (usually around 0.062 inches (1.57 millimeters) thick) in combination with single sheets of conductive film outer layers and core assemblies. These materials are laid up in the order of a steel plate, a conductive film layer, a core assembly, another conductive film layer, and another steel plate. This sequence is repeated for each printed circuit board in the book. The entire book is heated and subjected to pressure to bond the conductive outer layers to the core assembly and cure the prepreg. After cooling, the individual boards are separated from each other and subjected to final processing. This method is known as “conventional lamination.”

However, conventional lamination results in relatively high scrap rates. The scrap is due mainly to debris, such as resin dust or metal shavings, contaminating the conductive film that made up the outer layers. The source of this debris is often the environment where assembly took place or from the materials themselves. This debris causes damage to the conductive film outer layer during the lamination cycle. When the conductive film layer is imaged for the circuitry of the outer layer, the damaged areas where conductive pathways or other features landed often result in an open or short in the testing phase of the device and the device will need to be scrapped.

Another key contributor to damage on the copper surface of the outer layer is the kinks, folds and wrinkles that occur from the operator handling the thin conductive film during lay-up of the stack.

In the early 1990's, a category of products called “lamination foil” was developed to address the shortcomings of conventional lamination. Lamination foil is a laminate comprising a layer of electro-deposited conductive film that can be made of copper, gold, silver or some other conductive material, a stiff layer of alloy called the separator (most typically aluminum between 0.010 and 0.020 inches (254 and 506 microns) thick), and a second layer of conductive film. The surfaces of the separator and the adjacent conductive film surfaces are made to be clean and contaminate-free. In most versions of lamination foil, these clean surfaces are then sealed along all four borders by adhesives or mechanical welds. To assemble a book, a lamination foil is placed between each pair of core assemblies. The book is then subjected to heat and pressure to bond the conductive film layers to the adjacent core assembly. The conductive film layers thus become an outer layer of a printed circuit board. The separator is discarded after the lamination process.

By sealing the conductive film surface that is destined to become the outer layer of a printed circuit board, the debris that often caused defects in the conventional lamination method cannot enter the sealed package. Accordingly, the scrap rate relative to conventional lamination is dramatically reduced. In addition, the lamination foil separator acts to “stiffen” or provide structural support to the thin conductive film layers. This substantially reduces the damage that can occur while handling the discrete conductive film layers during lay-up in the conventional lamination technique.

The lamination foil separator also allowed manufacturers to largely discontinue the use of the steel plates used to assemble lamination books in the conventional lamination method. There are several benefits to not using steel plates. First, steel is a heat barrier. A lamination book built with steel plates between each device assembly takes more time and energy in the press to get to temperature. Second, the steel plates need ongoing maintenance to keep the surface defect free. Finally, the steel plates slow the assembly process prior to lamination and the disassembly process after lamination because of their weight.

Over the years the trend towards the miniaturization of electronics significantly increased the density or layer count of multi-level printed circuit boards. Manufacturers using lamination foil began to experience a phenomenon called “image transfer” in which the image of the circuitry from an underlying inner layer would get impressed into the copper layer that made up the outer layer despite the presence of the aluminum separator. The result of this “gravestone rubbing” effect was an outer layer with a rough topography that made subsequent processing much more difficult and resulted in much lower yields. Although harder aluminum separators were developed to reduce image transfer, the trend towards denser and denser circuitry devices did not stop. In certain situations, even the hardest aluminum available was unable to control image transfer and produce a smooth outer layer. To solve this problem, many manufacturers eventually came to the realization that the only way to avoid image transfer in some applications was to reintroduce the use of steel plates between each assembly in the lamination book. However, lamination foil continues to be used because it prevents contamination of the conductive film surfaces and facilitates handling of the extremely thin conductive films. So, in effect, the industry has moved back to a methodology that is almost identical to the conventional lamination techniques used before the introduction of lamination foil, but with the added expense of lamination foil.

In addition to its expense, another drawback to using lamination foil is a problem related to differential thermal expansion. When heated during the lamination process, the aluminum separator expands more than the copper film layers due to the different coefficients of thermal expansion of copper and aluminum. Because the copper film layers are bonded to the aluminum separator, this differential thermal expansion creates significant surface tension that could cause the adhesive seals to fail.

Accordingly, it would be desirable to provide a component for use in manufacturing printed circuit boards that retains the principle advantages of lamination foil while reducing the cost and thermal expansion problems associated with lamination foil.

### SUMMARY OF THE INVENTION

The above-mentioned need is met by the present invention, which provides a laminated component including a separator having first and second surfaces, a conductive film layer disposed against the first surface of the separator, and a non-conductive film layer disposed against the second surface of the separator. The conductive and non-conductive film layers both have larger lateral dimensions than the separator such that a portion of each film layer extends beyond the separator. The extending portions of the conductive and non-conductive film layers are joined together to seal the laminated component. In one embodiment, a band of adhesive is disposed on a first surface of the conductive film layer so as to define an enclosed central area inwardly thereof and the separator is placed within the central area. The extending portion of the non-conductive film layer is pressed against the adhesive to form a joint between the conductive film layer and the non-conductive film layer.

The present invention and its advantages over the prior art will be more readily understood upon reading the following detailed description and the appended claims with reference to the accompanying drawings.

### DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawing figures in which:

FIG. 1 is an exploded side view of a laminated component useful in manufacturing articles such as printed circuit boards.

FIG. 2 is a top view of the laminated component of FIG. 1 with the non-conductive film layer shown in partial cut-away.

FIG. 3 is an enlarged sectional side view of a portion of the laminated component.

FIG. 4 is a side view of a lamination book including a plurality of the laminated components of FIG. 1.

### DETAILED DESCRIPTION OF THE INVENTION

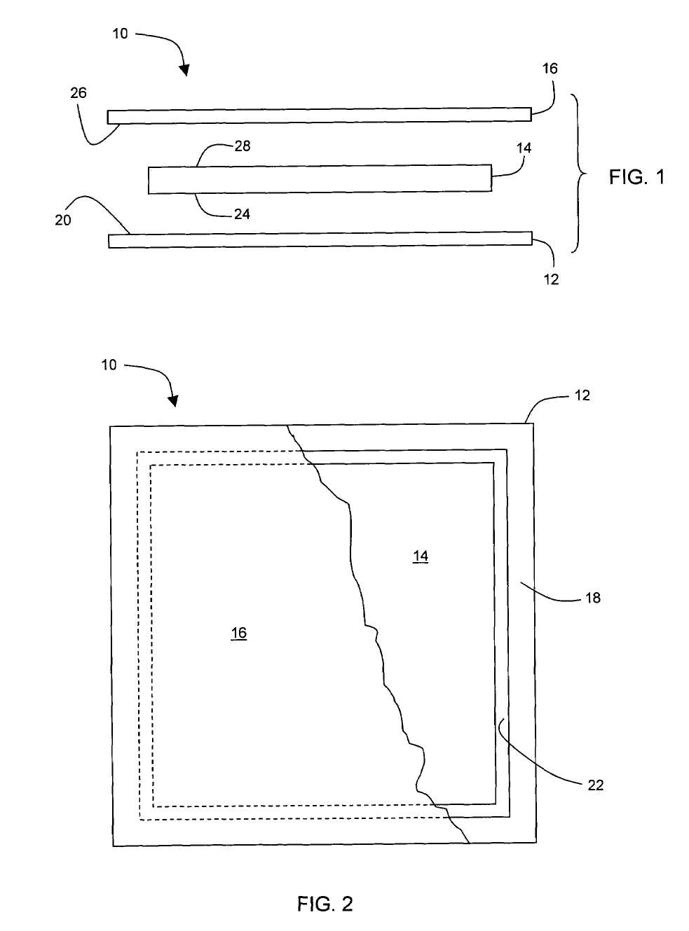

Referring to the drawings wherein identical reference numerals denote the same elements throughout the various views, FIGS. 1 and 2 show a laminated component 10 useful in manufacturing articles such as printed circuit boards. The component 10 comprises a conductive film layer 12, an intermediate layer or separator 14 and a non-conductive film layer 16. The conductive film layer 12 is a thin sheet of an electrically conductive material such as copper, gold, silver or the like. The component 10 is preferably applied under strict class 100 clean room conditions.

The conductive film layer 12 can be any thickness, but a thickness in the range of about 5-70 microns is typical. Adhesive 18 is applied on a first or inner surface 20 of the conductive film layer 12. The adhesive 18 is applied in strips along each of the four outer edges of the conductive film layer 12 so as to create a band that defines an enclosed central area 22 inwardly thereof on the inner surface 20. The adhesive 18 can be applied right at each outer edge of the conductive film layer 12 (as shown in FIG. 2) or slightly inward from the outer edges. As will be described below, the central area 22 will become the functional outer layer of a multi-level printed circuit board. Accordingly, the lateral dimensions of the central area 22 should match the intended lateral dimensions of the printed circuit board.

The separator 14 is preferably made of aluminum and can be any thickness, although a thickness sufficient to provide a degree of stiffness to the laminated component 10 is desirable. For an aluminum separator, a thickness in the range of about 0.010-0.030 inches (254 and 762 microns) is suitable. The relatively stiff separator 14 will provide structural support for the conductive film layer 12 and thus reduce damage to the conductive film layer 12 during handling of the component 10. While aluminum is a preferred material for the separator 14, other materials such as titanium, stainless steel, nickel alloys, ceramics or even some plastics could also be used. The separator 14 has lateral dimensions that are smaller than the central area 22. Through a precision process, the separator 14 is positioned within the central area 22, with a first surface 24 thereof disposed flat against the inner surface 20 of the conductive film layer 12.

The non-conductive film layer 16 is placed over the separator 14 so that a first or inner surface 26 of the non-conductive film layer 16 is disposed flat against a second surface 28 of the separator 14. The lateral dimensions of the non-conductive film layer 16 are larger than that of the separator 14 so that the non-conductive film layer 16 extends beyond the separator 14 on all sides thereof. Specifically, the non-conductive film layer dimensions at least match the dimensions of the strips of adhesive 18 and can be equivalent to the lateral dimensions of the conductive film layer 12, as is shown in the Figures. The non-conductive film layer 16 is a thin sheet of a non-conductive material such as aluminum, polytetrafluoroethylene (PTFE), or silicone. The non-conductive film layer 16 can be any thickness, but a thickness in the range of about 17.8-127 microns is typical.

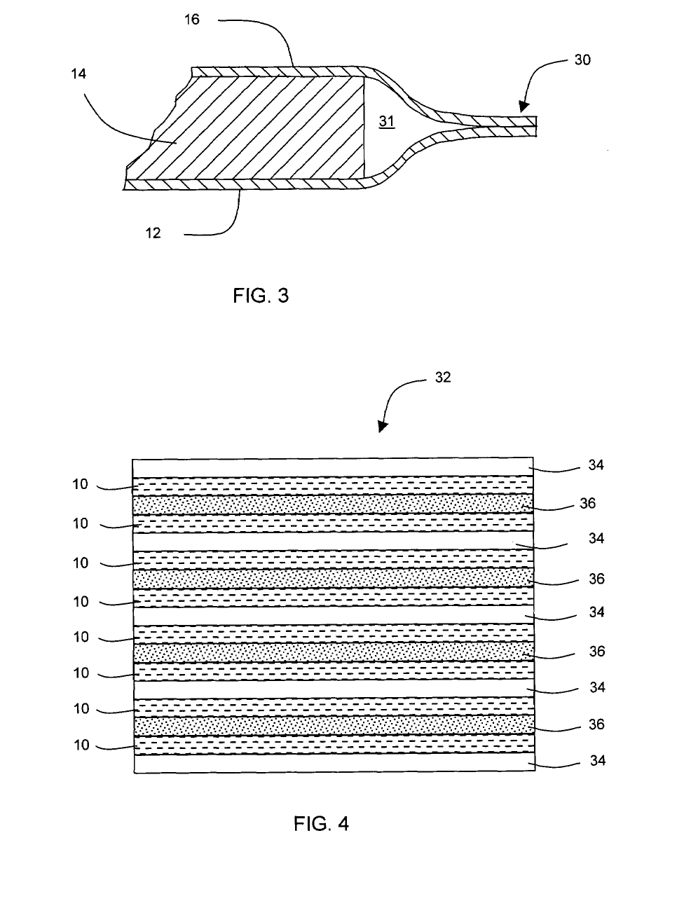

As best seen in FIG. 3, the portions of the conductive film layer 12 and the non-conductive film layer 16 that extend beyond the separator 14 are pressed together over the strips of adhesive 18 to form a joint 30. The adhesive 18 joins the inner surface 20 of the conductive film layer 12 to the inner surface 26 of the non-conductive film layer 16 along the entire peripheries of the two film layers 12 and 16. The joint 30 seals the interior of the component 10 from the external environment and aids in holding the separator 14 in place between the conductive and non-conductive film layers 12 and 16. As mentioned above, the component 10 is preferably assembled under strict class 100 clean room conditions so that the inner surfaces of the component 10 are as clean as possible. The seal joint 30 assures that the inner surfaces, particularly the central area 22 on the conductive film layer inner surface 20 (which will become the functional outer layer of a printed circuit board), will not be contaminated during subsequent lay-up and lamination processes. Tooling holes (not shown) are added to the component 10 per specification. While the adhesive 18 has been described above as being first applied to the conductive film layer 12, it could alternatively be applied to the non-conductive film layer 16 or to both film layers 12 and 16.

The joint 30 can be made by means other than adhesive. Alternatives for joining the portions of the conductive film layer 12 and the non-conductive film layer 16 that extend beyond the separator 14 include welding, soldering and mechanical means such as punching or stamping.

The separator 14 is thus held in position between the conductive film layer 12 and the non-conductive film layer 16 without being directly joined to either layer. Furthermore, because the separator 14 is smaller than the central area 22 defined by the adhesive 18, there is a space 31 between the edges of the separator 14 and the joint 30. This allows the aluminum separator 14 to freely expand relative to the conductive film layer 12 and thus eliminates surface tension and/or deformation of the conductive film layer 12 due to differential thermal expansion.

Referring to FIG. 4, a method for manufacturing multi-level printed circuit boards using the laminated component 10 is described. The various elements used in making the printed circuit boards are assembled into a lamination book 32. From bottom to top, the book 32 includes a first steel plate 34, a first laminated component 10, a core assembly 36, a second laminated component 10, and a second steel plate 34. As is known in the art, the core assembly 36 is a laminate comprising a stack of alternating prepreg layers and conductive inner layers with each inner layer having circuitry formed on both sides thereof. Each laminated component 10 is arranged so that its conductive film layer 12 abuts the adjacent core assembly 36 and its non-conductive film layer 16 abuts the adjacent steel plate 34. This sequence is repeated for each printed circuit board to be part of the book 32. While FIG. 4 shows a book assembly with four printed circuit boards, the present invention is not limited to this number.

The entire book 32 is then heated and subjected to pressure to cure the prepreg resin of the core assemblies 36 and bond the conductive film layers 12 to the corresponding core assemblies 36. After cooling, the steel plates 34 are removed from the book 32 leaving four board assemblies. The non-conductive film layers 16 and the separators 14 are separated from the bonded conductive film layers 12 and discarded. The bonded conductive film layers 12, particularly the central areas 22, remain as the functional outer layers of the resulting printed circuit boards.

While specific embodiments of the present invention have been described, it will be apparent to those skilled in the art that various modifications thereto can be made without departing from the spirit and scope of the invention as defined in the appended claims.

What is claimed is:

1. A laminated component for use in manufacturing articles such as printed circuit boards, said component comprising:
a separator having first and second surfaces;
a conductive film layer disposed against said first surface of said separator; and
a non-conductive film layer disposed against said second surface of said separator.

2. A laminated component for use in manufacturing articles such as printed circuit boards, said component comprising:
a separator having first and second surfaces;
a conductive film layer positioned on said first surface of said separator, said conductive film layer having larger lateral dimensions than said separator such that a portion of said conductive film layer extends beyond said separator; and
a non-conductive film layer positioned on said second surface of said separator, said non-conductive film layer having larger lateral dimensions than said separator such that a portion of said non-conductive film layer extends beyond said separator, wherein said extending portion of said conductive film layer and said extending portion of said non-conductive film layer are joined together.

3. The component of claim 2 wherein said extending portion of said conductive film layer and said extending portion of said non-conductive film layer are joined together by adhesive.

4. The component of claim 2 wherein said extending portion of said conductive film layer and said extending portion of said non-conductive film layer are joined together at the peripheries of said conductive film layer and said non-conductive film layer.

5. The component of claim 2 wherein said separator is made of aluminum.

6. The component of claim 5 wherein said separator has a thickness of about 254 and 762 microns.

7. The component of claim 2 wherein said conductive film layer is made of copper.

8. The component of claim 2 wherein said non-conductive film layer is made of a material selected from the group consisting of aluminum, polytetrafluoroethylene and silicone.

9. A laminated component for use in manufacturing articles such as printed circuit boards, said component comprising:
a conductive film layer having a band of adhesive disposed on a first surface thereof so as to define an enclosed central area inwardly thereof;
a separator placed on said first surface of said conductive film layer within said central area; and
a non-conductive film layer positioned on said separator, said non-conductive film layer having larger lateral dimensions than said separator such that a portion of said non-conductive film layer extends beyond said separator, wherein said extending portion of said non-conductive film layer is pressed against said adhesive to form a joint between said conductive film layer and said non-conductive film layer.

10. The component of claim 9 wherein said joint joins said conductive film layer and said non-conductive film layer together at their peripheries.

11. The component of claim 9 wherein said joint seals said central area.

12. The component of claim 9 further comprising a space between said separator and said joint.

13. The component of claim 9 wherein said separator is made of aluminum.

14. The component of claim 13 wherein said separator has a thickness of about 254 and 762 microns.

15. The component of claim 9 wherein said conductive film layer is made of copper.

16. The component of claim 9 wherein said non-conductive film layer is made of a material selected from the group consisting of aluminum, polytetrafluoroethylene and silicone.

17. A method of making printed circuit boards, said method comprising:
providing laminated components, each laminated component comprising a separator having first and second surfaces, a conductive film layer disposed against said first surface of said separator, and a non-conductive film layer disposed against said second surface of said separator;
assembling a book including a first steel plate, a first laminated component placed on said first steel plate, a core assembly placed on said first laminated component, a second laminated component placed on said core assembly, and a second steel plate placed on said second laminated component, wherein each laminated component is arranged so that its conductive film layer abuts said core assembly and its non-conductive film layer abuts a corresponding one of said steel plates; and
subjecting said book to heat and pressure.

18. The method of claim 17 further comprising separating said non-conductive film layers and said separators from said conductive film layers after subjecting said book to heat and pressure.
